(19) United States
(12) Patent Application Publication
(10) Pub. No.: US 2026/0091362 A1
(43) Pub. Date: Apr. 2, 2026

(54) MICROFLUIDIC DEVICE WITH A DEFORMABLE MEMBRANE ACTIVATABLE BY A HYDRAULIC CIRCUIT

(71) Applicant: COMMISSARIAT A L'ENERGIE ATOMIQUE ET AUX ENERGIES ALTERNATIVES, Paris (FR)

(72) Inventor: Yves FOUILLET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/345,313

(22) Filed: Sep. 30, 2025

(30) Foreign Application Priority Data
Oct. 2, 2024 (FR) FR2410595

(51) Int. Cl. B01F 33/30; B01F 35/221; B01F 35/71; B01F 101/40

(52) U.S. Cl. CPC B01F 33/305; B01F 35/2213; B01F 35/71761; B01F 35/71805; B01F 2101/40

(57) ABSTRACT

A microfluidic device including a microfluidic circuit having a microfluidic inlet duct and a microfluidic outlet duct, and a microfluidic capsule, a hydraulic activation circuit having a hydraulic inlet duct and a hydraulic outlet duct, the microfluidic capsule having a chamber separated into two subspaces by a deformable membrane, the chamber having a first subspace into which open the microfluidic inlet duct and the microfluidic outlet duct, and a second subspace into which open the hydraulic inlet duct and the hydraulic outlet duct, a flow rate-control system connected to the hydraulic inlet duct, the flow rate-control system being regulated in order to inject or suck an activation liquid into the second subspace in order to displace the membrane inside the chamber.

### FIELD OF THE INVENTION

The invention relates to a microfluidic device having a deformable membrane, the membrane being activatable by means of a hydraulic circuit.

### PRIOR ART

A microfluidic capsule currently used in a microfluidic card has a membrane which can be deformed between two positions inside a chamber in order to control the passage of fluid between an inlet duct and an outlet duct. This type of capsule can be employed to form a peristaltic-type pump. The capsule is often activated using pneumatic means connected to a regulation duct which opens out at the membrane. Exerting a positive or negative pressure via this regulation duct allows the membrane to be deformed between its two positions inside the chamber. It is difficult to control the flow rate at which the chamber is drained by way of pneumatic-type regulation. This flow rate is indeed dependent on the deformation of the membrane, on its elasticity, as well as on the pressure downstream of the chamber. Depending on the application, the downstream pressure is unknown, variable and ungovernable and it is thus very difficult to drain a chamber at a prescribed and controlled flow rate.

The patent application US2008/311585A1 describes a microfluidic device adapted to control chemical reactions.

The object of the invention is to propose a microfluidic device in which it is possible to control the flow rate at which the chamber of a microfluidic capsule is drained, thus opening up new applications.

### DESCRIPTION OF THE INVENTION

This object is achieved by a microfluidic device comprising:
A microfluidic circuit having a microfluidic inlet duct equipped with a first valve, and a microfluidic outlet duct equipped with a second valve, and a microfluidic capsule,
A hydraulic activation circuit having a hydraulic inlet duct and a hydraulic outlet duct equipped with a third valve,
The microfluidic capsule having a chamber separated into two subspaces by a deformable membrane, the said chamber having a first subspace into which open the microfluidic inlet duct and the microfluidic outlet duct, and a second subspace into which open the hydraulic inlet duct and the hydraulic outlet duct,
A control unit,
The device having:
A flow rate-control system connected to the hydraulic inlet duct,
A liquid reservoir connected to the hydraulic outlet duct,
The said flow rate-control system being regulated by the said control unit in order to inject or suck an activation liquid into the said second subspace in order to displace the said membrane inside the chamber.

It should be noted that the deformable membrane used in the microfluidic capsule is currently made from a gas-permeable material. Maintaining it in a state by a pneumatic action would thus cause the occurrence of air bubbles which can thus propagate into the microfluidic network owing to this permeability. This problem can be overcome by the principle of the invention using a liquid for the activation of the membrane.

According to one feature, the flow rate-control system is a device of the syringe-pump type. According to another feature, the device has a fourth valve placed on the hydraulic inlet duct.

The invention also relates to a microfluidic system having a matrix of microfluidic devices, each microfluidic device being as defined above, the said matrix having M columns and N lines, M being greater than or equal to 1 and N being greater than or equal to 2, the microfluidic outlet duct of a first microfluidic device being connected on each line and/or each column to the microfluidic outlet duct of a second microfluidic device via a joining zone. According to one feature, the microfluidic outlet duct of the second microfluidic device is duplicated so as to form a joining zone, with shear flow, on the microfluidic duct of the first microfluidic device. According to another feature, the microfluidic devices of a same column share the same flow rate-control system. According to another feature, the microfluidic devices of the matrix share the same liquid reservoir.

The invention also relates to a method for controlling the flow rate of a fluid, this method being implemented with the aid of a microfluidic device as defined above, the method consisting in regulating the flow rate-control system of the said microfluidic device with a view to sucking or injecting an activation liquid into the second subspace of the chamber in order to control a displacement of its membrane and to control the displacement of the said fluid towards the inside or the outside of the first subspace of the chamber.

### SHORT DESCRIPTION OF THE FIGURES

Other features and advantages will become apparent from the following detailed description which is made with reference to the attached drawings, in which:

FIG. 1 shows schematically the architecture of the microfluidic device of the invention;

FIGS. 2A to 2C illustrate a first operating mode of the microfluidic device of the invention;

FIGS. 3A to 3C illustrate a first operating mode of the microfluidic device of the invention;

FIG. 4 shows a first architecture of a microfluidic system forming a first example of application of the microfluidic device of the invention;

FIG. 5 shows a second architecture of a microfluidic system forming a second example of application of the microfluidic device of the invention.

### DETAILED DESCRIPTION OF AT LEAST ONE EMBODIMENT

The invention applies to the regulation of a microfluidic capsule employed in a conventional fashion in a microfluidic device. This type of microfluidic device D is often employed in a microfluidic card. A microfluidic card is notably employed in the medical sector for analysing a fluid such as a liquid sample (blood, for example) by being connected to an automatic analysing device. The microfluidic card can thus incorporate a whole microfluidic network consisting of microfluidic elements such as microfluidic capsules in the form of valves or pumps, and microfluidic ducts. A microfluidic card can be made in a single layer or by assembling multiple layers with one another. Its layers are, for example, assembled with one another by heat sealing. Each layer can be machined so as to create therein at least part of the microfluidic network of the card, the assembling of the layers by being stacked on top of one another making it possible to form the whole microfluidic network of the microfluidic card. The microfluidic card has two opposite faces, each extending in two dimensions X, Y, and has a small thickness (a few mm) in the dimension Z compared with the two other dimensions.

The microfluidic card is advantageously made from a transparent material of the type COP (cyclo olefin polymer), COC (cyclo olefin copolymer), PMMA (polymethyl methacrylate), PDMS (polydimethylsiloxane), silicon, etc.

The microfluidic network of the microfluidic card can have one or more microfluidic capsules.

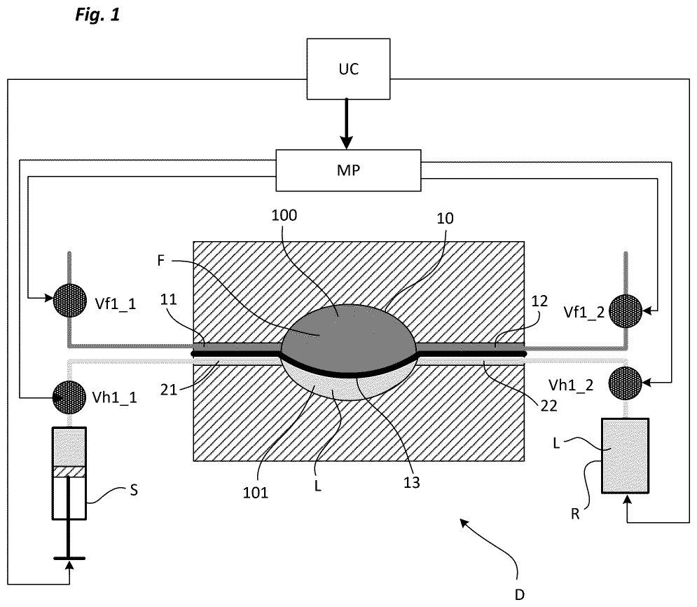

With reference to FIG. 1, a microfluidic capsule has in a conventional fashion a chamber 10 into which opens a microfluidic inlet duct 11 and a microfluidic outlet duct 12. For the sake of clarity, in the attached Figures the ducts 11 and 21 are shown as superposed but it should be understood that they can be arranged orthogonally in two planes of the card.

The microfluidic capsule also has a membrane 13 which can be deformed between at least two positions inside the chamber. The membrane divides the chamber into two subspaces 100, 101 and, depending on its position, modulates the ratio by volume between the two subspaces. The first subspace 100 is, for example, positioned above the second subspace 101. The microfluidic inlet duct 11 and the microfluidic outlet duct 12 each open only into this first subspace 100 of the chamber 10. The membrane 13 can assume a first position, termed the lower position (as in FIG. 1), in which it permits the first subspace of the chamber to be filled with the fluid F via the inlet fluid duct 11 and a second position, termed the upper position, in which it pushes the liquid back towards the outlet fluid duct 12. In its upper position, the membrane 13 is, for example, held flat against a wall of the cavity and blocks any passage of liquid between the two ducts. The terms “upper position” and “lower position” are of course to be considered as non-limiting.

The membrane 13 is, for example, interposed between two layers of the microfluidic card and is sealed between these two layers. The membrane is, for example, made from a hyperelastic material such as silicone (of the PDMS type, Ecoflex Silpuran from Wacker-both trademarks) or from TPU.

The microfluidic inlet duct 11 is equipped with a first valve Vf1_1 and the microfluidic outlet duct 12 is equipped with a second valve Vf1_2. The first valve and the second valve are advantageously of the pneumatic type and are each regulated respectively to permit or block the filling of the chamber 10, and to permit or block the evacuation of the chamber, depending on the activation of the membrane 13.

According to the invention, in order to activate the membrane 13 between its two positions, the microfluidic device uses a hydraulic circuit. The hydraulic circuit has a hydraulic inlet duct 21 opening into the second subspace 101 of the chamber 10 and a hydraulic outlet duct 22 also opening into the second subspace 101 of the chamber. Within the scope of the invention, the membrane 13 is activated between its two positions with the aid of an activation liquid L present in the hydraulic circuit. This activation liquid L is pressurized or depressurized in order to push or suck the membrane 13 between its two positions. The hydraulic inlet duct 21 is also advantageously equipped with a third valve Vh1_1 and the hydraulic outlet duct 22 is equipped with a fourth valve Vh1_2. The valves are advantageously of the pneumatic type. These can be valves which use the same deformable membrane 13 as that of the microfluidic capsule.

It should be noted that the microfluidic circuit is intended for the circulation of the fluid F, the circulation of which it is desired to control, the fluid advantageously being a liquid which can contain one or more reagents, and that the hydraulic circuit is intended for the circulation of the activation liquid L required for the activation of the membrane 13 of the capsule.

The fluid F and the activation liquid L are physically separated and never come into contact with each other, being separated by the membrane 13 in the chamber 10. The fluid F is intended to occupy the first subspace 100 of the chamber 10 of the capsule and the activation liquid L is intended to occupy the second subspace 101 of the chamber 10 of the capsule. The activation liquid L is thus never in physical contact with the fluid F, the two being separated by the presence of the membrane 13.

Within the scope of the invention, the microfluidic device also has a flow rate-control system S connected to the hydraulic inlet duct 21 and a liquid reservoir R connected to the hydraulic outlet duct 22. The flow rate-control system S functions as a hydraulic pump with a prescribed flow rate. It can, for example, be a syringe pump (as in the attached drawings) or a peristaltic pump or any other pump mechanism in which the flow rate can be controlled over a wide pressure range. The aim of this system is indeed to be able to control the quantity of activation liquid L in the hydraulic circuit with a view to controlling the displacement of the membrane 13, and ultimately to control the flow rate of the fluid F present in the microfluidic circuit. The reservoir R of activation liquid L is advantageously pressurized either to an elevated pressure or to a reduced pressure. This possibly allows the membrane 13 to be activated solely by pressure without using the flow rate-control system S (as in the prior art). The microfluidic device also has a control unit UC associated with pneumatic regulation means MP in order to control each valve and configured to regulate the flow rate-control system S and the reservoir R. The control unit UC is configured to regulate the flow rate-control system S so as to be able adjust the flow rate and the pressure of the activation liquid L in the hydraulic circuit and hence the position of the membrane 13 in the capsule.

Two operating modes of the device of the invention are presented below in a non-limiting fashion. In the Figures, the valves shown in dark grey are in the closed state (they do not allow the fluid or the activation liquid to pass through) and the valves shown in light grey are in the open state (they allow the fluid or the activation liquid to pass through).

### First Operating Mode

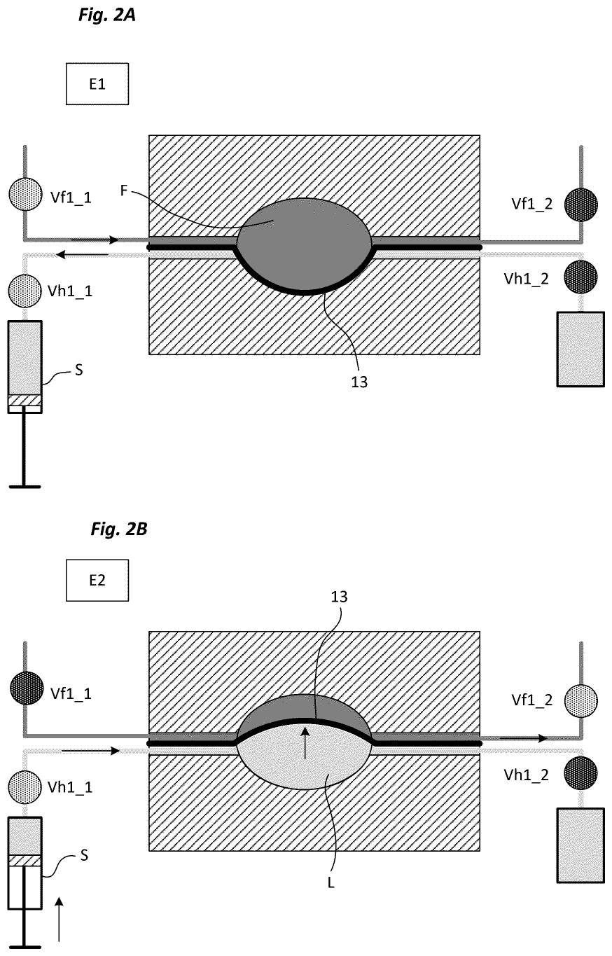

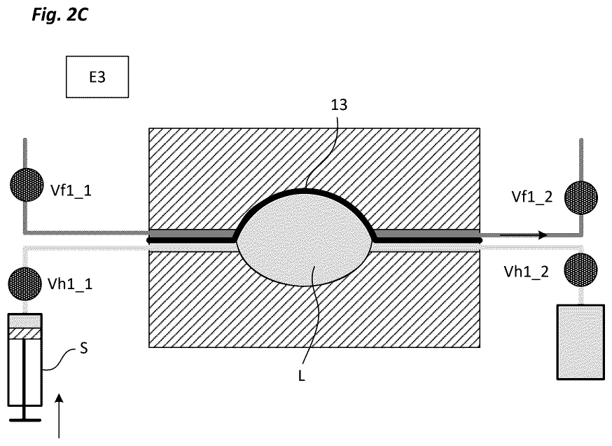

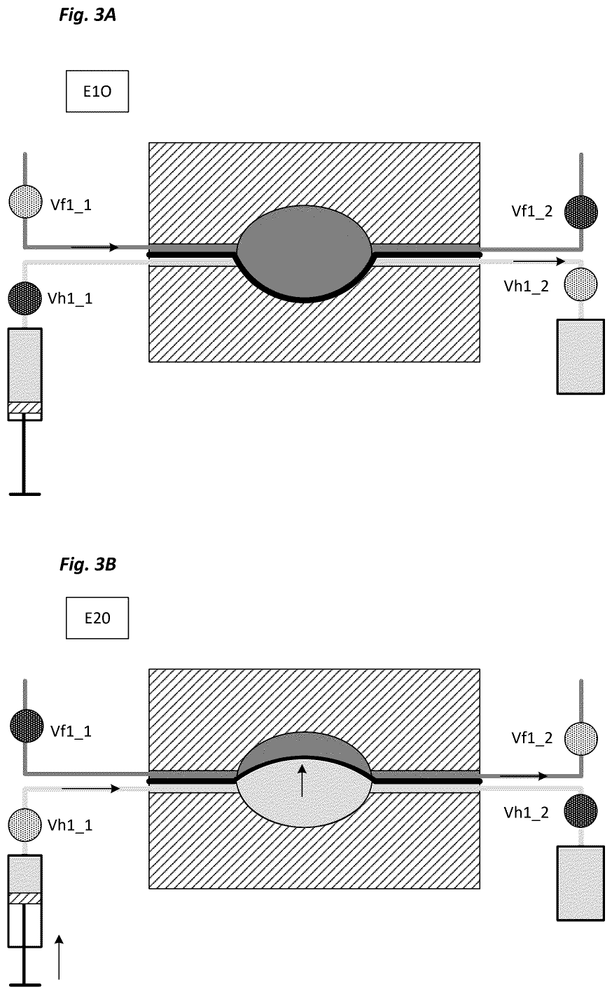

### FIG. 2A

### FIG. 2B

### FIG. 2C

Initially, all the valves are closed and the membrane is held in the upper position (as in FIG. 1).

E1—FIG. 2A: The valve Vh1_1 and the valve Vf1_1 are controlled so they are in the open state. The flow rate-control system S is controlled to apply suction in order to suck in an identical volume to that of the chamber 10. The membrane 13 is thus displaced towards its lower position. The fluid F present in the microfluidic circuit is hence sucked into the first subspace 100 of the chamber.

E2—FIG. 2B: The valve Vf1_1 is closed and the valve Vf1_2 is open. The flow rate-control system S is regulated to adopt injection mode at a prescribed flow rate and for a prescribed volume which is less than or equal to the volume of the chamber 10. The fluid F is thus injected with a controlled flow rate downstream of the chamber 10, via the microfluidic outlet duct 12.

E3—FIG. 2C: The valves are all closed and the membrane 13 is in the upper position.

A new cycle can be programmed according to the same principle.

### Second Operating Mode

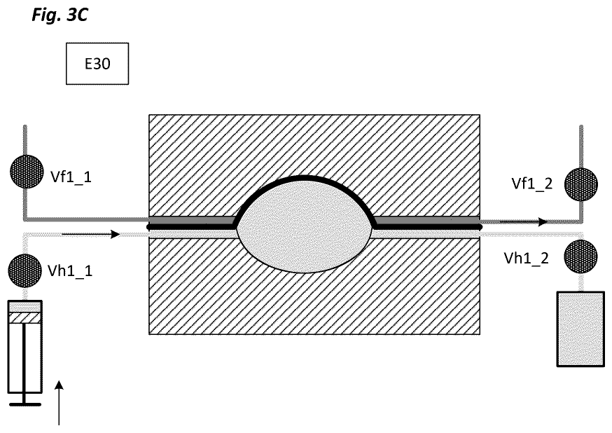

### FIG. 3A

### FIG. 3B

### FIG. 3C

Initially, all the valves are closed and the membrane 13 is held in the upper position (as in FIG. 1).

E10—FIG. 3A: The valve Vf1_1 and the valve Vh1_1 are controlled so they are in the open state. A reduced pressure is applied to the reservoir R. This reduced pressure allows the membrane 13 to be applied flat in the lower position and the fluid F to be sucked into the first subspace 100 of the chamber.

E20—FIG. 3B: The valve Vf1_1 and the valve Vh1_2 are controlled so they are in the closed state. The valve Vf1_2 and the valve Vh1_1 are controlled so they are in the open state. The flow rate-control system S is regulated to adopt injection mode at a prescribed flow rate in order to inject a volume of activation liquid L which is less than or equal to the volume of the chamber 10. The fluid F is thus injected with a controlled flow rate downstream of the chamber 10, via the microfluidic outlet duct 12.

E30—FIG. 3C: The valves are all closed and the membrane 13 is in the upper position.

A new cycle can be programmed according to the same principle.

It is moreover possible for a plurality of microfluidic devices as described above to be combined in different architectures with a view to meeting the needs of different applications. Two architectures are thus described below.

### First Architecture

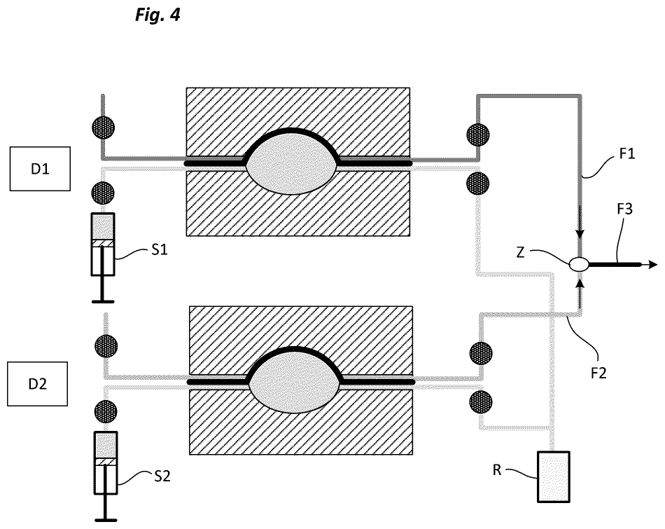

### FIG. 4

In this first architecture, two microfluidic devices D1, D2 as described above are placed in parallel. The two microfluidic outlet ducts of the two capsules are interconnected at a joining zone Z, leading to a common microfluidic duct.

This architecture can be employed to mix two distinct fluids F1, F2. The flow rate delivered by each microfluidic capsule towards the joining zone Z and hence the common microfluidic duct is thus governed.

In this configuration, the reservoir R can be shared by the two devices.

Each unit is equipped with its own flow rate-control system S1, S2.

For example, the first fluid F1 is an aqueous solution and the second fluid F2 is oil. By controlling the flow rate of the fluid at each device by means of its flow rate-control system, it is possible to create a fluid F3 in the form of an emulsion of drops at the joining zone Z. The size of the drops formed in the common microfluidic duct is a function of the two flow rates prescribed by the two flow rate-control systems S1, S2.

The valves of each device D1, D2 are as described above and they are controlled according to the first operating mode or the second operating mode described above.

### Second Architecture

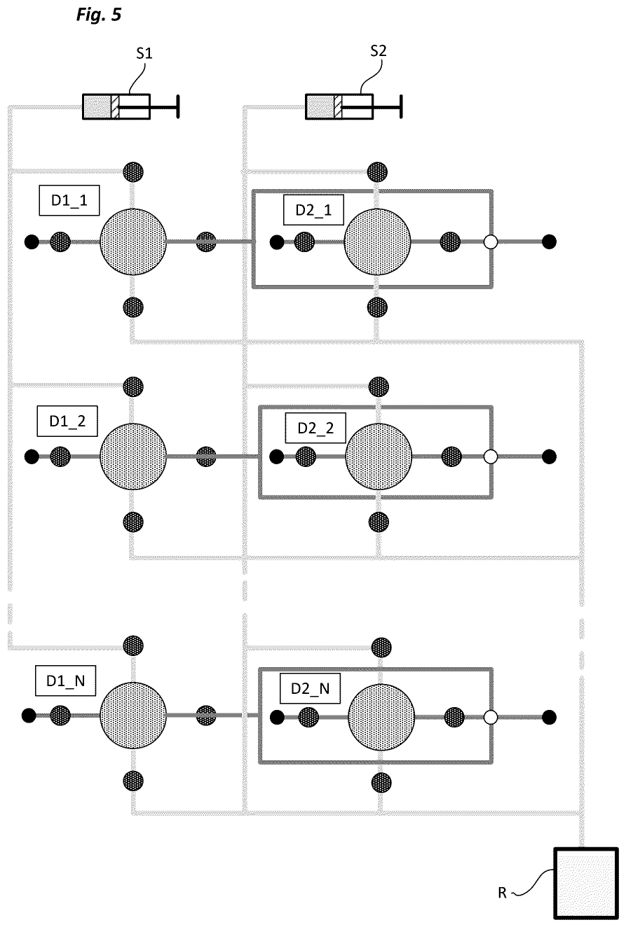

### FIG. 5

It is possible to replicate the abovedescribed principle for a plurality of devices forming a matrix with a plurality of columns and a plurality of lines. A matrix is defined, for example, with M columns and N lines, M being greater than or equal to 1 and N greater than or equal to 2. Each device is designated with an index i_j, where i ranges from 1 to M and j ranges from 1 to N. Two columns are shown in FIG. 5.

In this architecture, each device Di_j is dedicated to controlling the injection of a distinct fluid.

By way of example, all the devices present on the same line j are interconnected via a joining zone leading to a common microfluidic outlet duct.

All the microfluidic devices of the same column share, for example, their flow rate-control system Si (S1 and S2 in FIG. 5).

The reservoir R of pressurized liquid is, for example, common and shared by all the devices Di_j of the matrix.

On each line j, the microfluidic outlet duct of the device Di_j is duplicated so as to be connected to the microfluidic outlet duct of the device Di+1_j with shear flow.

FIG. 5 shows a matrix having two columns (M=2) and N lines. With such a matrix, the operating principle is described below.

Initially, all the valves are closed and all the membranes are held in the upper position.

In the first operating mode or the second operating mode described above, the first subspace 100 of the chamber of each device is filled with fluid controlled by each device.

By controlling the two flow rate-control systems S1, S2, each dedicated to a separate column, N mixtures are performed in sequence on each line of the matrix. The mixtures are made line by line, one line after the other. Whilst one line is active, the others can remain on standby, i.e. be inactive. It is also possible to wash the microfluidic circuits of the devices of the inactive lines. In this case, a microfluidic washing circuit (not shown) can be connected thereto.

It is also possible to provide a multi-way fluid-distribution valve at the outlet of each flow rate-control system. Each valve can then be controlled in order to connect the flow rate-control system S to one device of the column in particular or to a plurality of devices of the column.

This second architecture is particularly advantageous in the case of an LNP formulation (lipid nanoparticles). This application requires the ability to mix a solution containing lipids with an aqueous solution very quickly. The size of the nanoparticles produced depends on the geometry of the component and on the flow rates of the two solutions. It is therefore imperative to govern the flow rates of injections. The flow rates are in the order of several ml/mn. The production of a few hundred μl of reactions therefore has to be very fast.

The invention has numerous advantages, including:
It allows the fluid flow rate of a microfluidic capsule to be controlled precisely via the use of a hydraulic circuit;
The device D has a configuration in which the microfluidic part containing the reagents and the hydraulic regulation part are physically separated, avoiding any risk of contamination and reducing the contact surface area with the reagents, which reduces the cleaning times of the system;
The device of the invention is adapted to be replicated in lines and columns in order to form a matrix dedicated to a particular application;
The solution of the invention opens up various applications such as creating drops of different sizes by controlling the flow rates, or creating nanoparticles.

1. A microfluidic device comprising:
a microfluidic circuit having a microfluidic inlet duct equipped with a first valve, and a microfluidic outlet duct equipped with a second valve, and a microfluidic capsule,
a hydraulic activation circuit having a hydraulic inlet duct and a hydraulic outlet duct equipped with a third valve,
said microfluidic capsule having a chamber separated into two subspaces by a deformable membrane, said chamber having a first subspace into which open the microfluidic inlet duct and the microfluidic outlet duct, and a second subspace into which open the hydraulic inlet duct and the hydraulic outlet duct,
a control unit,
wherein the microfluidic device has:
a flow rate-control system connected to the hydraulic inlet duct,
a liquid reservoir connected to the hydraulic outlet duct,
said flow rate-control system being regulated by said control unit in order to inject or suck an activation liquid into said second subspace in order to displace said membrane inside the chamber.

2. The device according to claim 1, wherein the flow rate-control system is a syringe-pump.

3. The device according to claim 1, wherein the device has a fourth valve placed on the hydraulic inlet duct.

4. The microfluidic system, comprising a matrix of microfluidic devices, each microfluidic device being as defined in claim 1, said matrix having M columns and N lines, M being greater than or equal to 1 and N being greater than or equal to 2, and wherein the microfluidic outlet duct of a first microfluidic device is connected on each line and/or each column to the microfluidic outlet duct of a second microfluidic device via a joining zone.

5. The system according to claim 4, wherein the microfluidic outlet duct of the second microfluidic device is duplicated so as to form a joining zone, with shear flow, on the microfluidic duct of the first microfluidic device.

6. The system according to claim 4, wherein the microfluidic devices of a same column share the same flow rate-control system.

7. The system according to claim 4, wherein the microfluidic devices of the matrix share the same liquid reservoir.

8. A method for controlling the flow rate of a fluid, wherein the flow rate of a fluid is implemented with the microfluidic device as defined in claim 1, and wherein said method includes regulating the flow rate-control system of said microfluidic device with a view to sucking or injecting an activation liquid into the second subspace of the chamber in order to control a displacement of its membrane and to control the displacement of said fluid towards the inside or the outside of the first subspace of the chamber.
